(19) United States
(12) Patent Application Publication
(10) Pub. No.: US 2026/0225101 A1
(43) Pub. Date: Aug. 6, 2026

(54) Radiopharmaceutical Instant Thin Layer Chromatography System and Methods of Use

(71) Applicant: The Board of Regents of the University of Oklahoma, Norman, OK (US)

(72) Inventors: Trimelle Polk, Yukon, OK (US); Wendy Galbraith, Norman, OK (US); Francisco Robles, Rio Rico, AZ (US)

(73) Assignee: The Board of Regents of the University of Oklahoma, Norman, OK (US)

(21) Appl. No.: 19/467,761

(22) Filed: Feb. 2, 2026

Related U.S. Application Data
(60) Provisional application No. 63/753,379, filed on Feb. 3, 2025.

(51) Int. Cl. B01L 3/00; G06F 11/3668

(52) U.S. Cl. CPC B01L 3/5082; G06F 11/3688

(57) ABSTRACT

An RCP test system is provided for developing a radiopharmaceutical sample with a test strip and a solvent during an RCP test. The RCP test system includes a test template specific to the radiopharmaceutical sample and a cassette configured to hold the test strip in proper registration with the template. The cassette includes a channel configured to retain the test strip during the RCP test and a solvent well configured to retain a selected volume of the solvent. The solvent well and channel cooperate to place the test strip at a suitable depth in the solvent within the solvent well. The test template includes a sample aperture, a cut line window, and a solvent front window. The test template can be provided with visible indicia that includes information about the specific RCP test.

### RELATED APPLICATIONS

The present application claims the benefit of U.S. Provisional Patent Application Ser. No. 63/753,379 filed Feb. 3, 2025 and entitled, “Radiopharmaceutical Instant Thin Layer Chromatography System and Methods of Use,” the disclosure of which is herein incorporated by reference.

### BACKGROUND

Radiopharmaceuticals are short lived radioactive pharmaceuticals that must be prepared the day of administration or just prior to administration. The prepared radiopharmaceutical must undergo quality control (QC) testing for purity before it is administered to the patient because of potential for radiochemical impurities. QC is a subdivision or form of quality assurance that focuses on evaluation of the material and products (i.e., radiopharmaceutical preparations) for minimum acceptance standards specified by the United States Pharmacopeia (USP), and specifications approved by the Food and Drug administration (FDA) of a products chemistry, manufacturing, and controls (CMC). These standards and specifications are derived from radiopharmaceutical manufacturers and scientific literature. If the radiochemical purity is below industry standards, unexpected patterns of radiopharmaceutical biodistribution will put a patient at risk for increased radiation exposure, potential misdiagnosis and delayed treatment.

The primary responsibility for the quality of the radiopharmaceutical rests with the manufacturer, but it is the responsibility of the end user to verify quality control to ensure the purity of the preparation before patient administration. The State Board of Pharmacy, the NRC or state agreement agency, and the FDA can all regulate radiopharmaceuticals which are sterile and non-sterile drugs. It is indirectly regulated by reimbursement providers through accreditation agencies like The Joint Commission. Improper administrations and adverse events may be investigated by the end user's institution e.g., safety board, the NRC, and the FDA if the situation causes substantial harm. The United States Pharmacopeia General Chapter on Radiopharmaceuticals requires end product radiochemical purity documentation for each radiopharmaceutical administered.

Radiochemical purity (RCP) is the percentage of total radioactivity present in a preparation in the specified chemical form. The RCP can be measured by a number of methods, but thin layer chromatography (TLC) is used more than any other method for FDA approved radiopharmaceuticals. The standard for technetium-99 m labeled radiopharmaceuticals is instant thin layer chromatography (ITLC). ITLC is one of the most simple and inexpensive preparation systems. ITLC is a technique especially used for analyzing many 99 mTc-labeled radiopharmaceuticals. The technique requires only microliters of a sample of the prepared radiopharmaceutical for an assay. The sample is spotted on the origin of the appropriate chromatographic strip media (solid phase) and the proper solvent (mobile phase) added in a test tube. The strip is inserted gently in the test tube, oriented vertically where the origin is close to the bottom of the test tube but not immersed in the solvent. The mobile phase carries the sample through the solid phase until the mobile phase reaches a solvent front line. The test strip can then be cut and the two portions of the strips can be analyzed in the appropriate radiation detection equipment. Suitable systems using the current technology are available from Mirion Technologies, Inc. under the Tec-Control Chromatography Systems line of products.

Although widely adopted, the current ITLC system lacks a convenient and consistent display and marking information for each radiopharmaceutical chromatographic system, i.e., the appropriate media, solvent, solvent front line, and relative front (Rf) cut line. The existing systems present problems for technicians who are unfamiliar with the testing procedure. In addition to having many different systems of solid phase paper in combinations with different mobile phase solvents, there are many pitfalls for the individual when performing RCP. For example, the current systems are prone to error from users not knowing the characteristics of the impurity being tested for in a given RCP system, selecting the wrong solvent or media for the radiopharmaceutical, applying the improper analytical calculations for a given RCP system, immersing the sample in solvent by spotting the sample too low on the solid phase, immersing the sample from loading too much volume of mobile solvent for the system, applying an insufficient volume of solvent, contaminating solid media by handling with bare hands, uneven spotting of the radiopharmaceutical sample, using markers that may alter the degree of solubility of the radiopharmaceutical preparation or the impurity, using test strips or solvents that have become contaminated or inactive, allowing the solvent front to develop beyond the top of the solid phase media, mispositioning the solid phase paper strip, cross-contaminating developing vials, altering media divisions by not using the separation marks, and failing to resolve variability among practices employed by technicians and technologists.

There is, therefore, a need for an improved RCP system and method. The present disclosure is directed to addressing these and other deficiencies in the prior art.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function.

FIG. 1 is a front view of an RCP cassette constructed in accordance with an exemplary embodiment.

FIG. 2 is a side cross-sectional view of the RCP cassette of FIG. 1.

FIG. 3 is a front perspective view of the RCP cassette of FIG. 1.

FIG. 4 is a front perspective view of the RCP cassette of FIG. 1 with two test strips loaded into the RCP cassette.

FIG. 5 is a front view of a test template constructed in accordance with an exemplary embodiment.

FIG. 6 depicts the placement of the test template of FIG. 5 in the RCP cassette of FIG. 4.

### DETAILED DESCRIPTION

The present disclosure is directed, in non-limiting embodiments, to a system and method for carrying out an RCP test using an ITLC process. The system includes an RCP cassette and test template that together form an RCP test system that alleviates many of the shortcomings of prior art RCP test kits. In exemplary embodiments, the RCP test system facilitates the: (i) accurate placement of test strips (solid phase); (ii) addition of an appropriate volume and level of solvent (mobile phase) relative to the test strips; (iii) appropriate spotting of the sample on the origin of the test strips; (iv) appropriate placement of the (Rf) cut line on the test strips; (v) identification of the appropriate destination of the solvent front on the test strips; and (vi) analytical calculations by presenting the applicable equations and conversion factors on the test template, together with the types of test strip and solvent appropriate for the given RCP test.

Before describing various embodiments of the present disclosure in more detail by way of exemplary description, examples, and results, it is to be understood as noted above that the present disclosure is not limited in application to the details of methods and apparatus as set forth in the following description. The present disclosure is capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

As utilized in accordance with the methods and apparatus of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used herein, all numerical values or ranges (e.g., in units of length such as micrometers or millimeters) include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. It is to be understood that the terms “including”, “comprising”, “consisting” and grammatical variants thereof do not preclude the addition of one or more components, features, steps, or integers or groups thereof and that the terms are to be construed as specifying components, features, steps or integers.

It is to be understood that where the specification states that a component, feature, structure, or characteristic “may”, “might”, “can” or “could” be included, that particular component, feature, structure, or characteristic is not required to be included. The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error. Further, in this detailed description, each numerical value (e.g., temperature or time) should be read once as modified by the term “about” (unless already expressly so modified), and then read again as not so modified unless otherwise indicated in context. As noted above, any range listed or described herein is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range. Unless otherwise stated, the term “about” or “approximately”, where used herein when referring to a measurable value such as an amount, length, thickness, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement (e.g., length).

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. As used herein any reference to “we” as a pronoun may include laboratory personnel or other contributors who assisted in the laboratory procedures and data collection and is not intended to represent an inventorship role by said laboratory personnel or other contributors in any subject matter disclosed herein.

Where applicable, although state diagrams, flow diagrams or both may be used to describe embodiments, the present disclosure is not limited to those diagrams or to the corresponding descriptions. For example, flow need not move through each illustrated box or state, or in exactly the same order as illustrated and described. Methods of the present disclosure may be implemented by performing or completing manually, automatically, or a combination thereof, selected steps or tasks. The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility). Still further, additional aspects of the various embodiments of the instant disclosure may be found in one or more appendices attached hereto and/or filed herewith, the disclosures of which are incorporated herein by reference as if fully set out at this point.

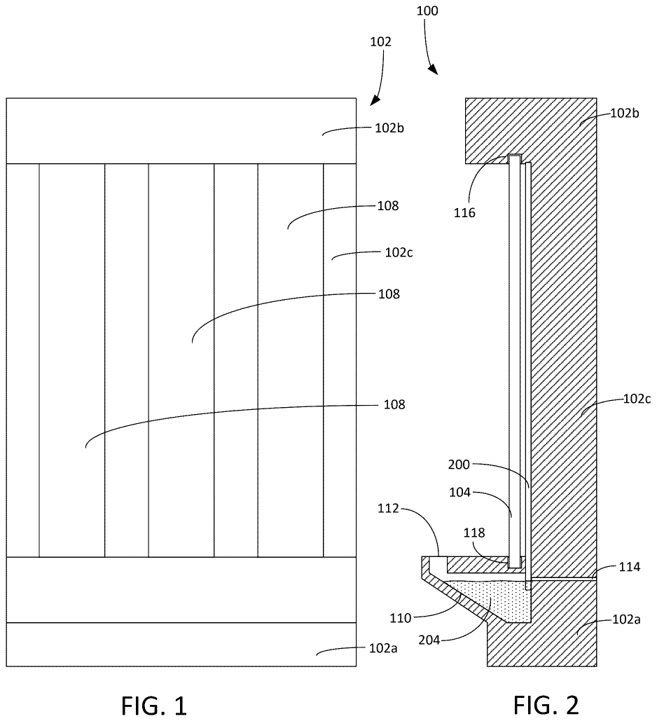

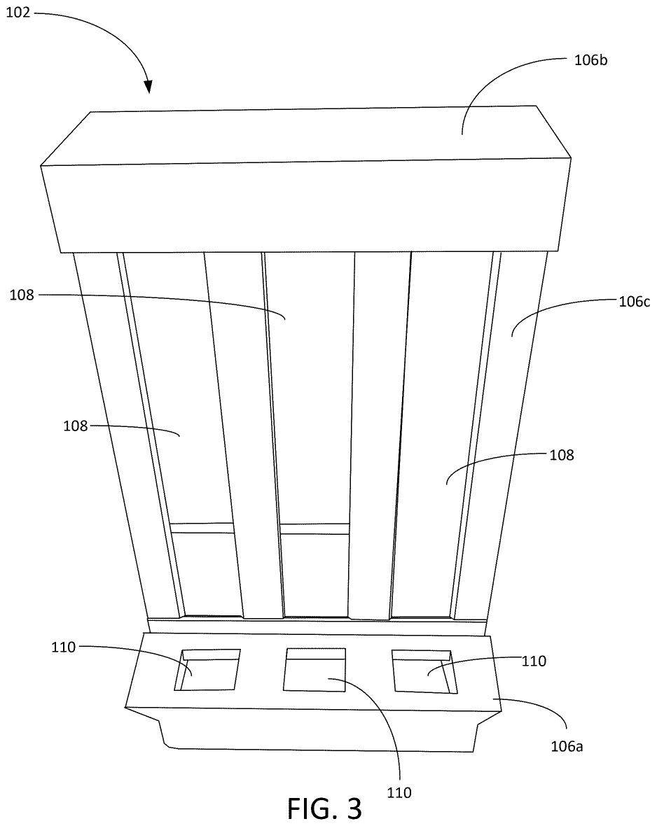

Turning to FIGS. 1-6, shown therein are various views of a radiochemical purity (RCP) test system 100 constructed in accordance with exemplary embodiments. The RCP test system 100 includes a cassette 102 and a test template 104 that is configured to be easily installed on and removed from the cassette 102. As explained below, the template 104 can be a test-specific template that is designed for assisting the accurate and repeatable testing of radiochemical purity of a known radioactive pharmaceutical.

The cassette 102 includes a substantially box-shaped cassette body 106. In exemplary embodiments the cassette body 106 includes a cassette body base 106a, a cassette body head 106b, and a cassette body riser 106c that extends between the cassette body base 106a and cassette body head 106b. In some embodiments, the cassette body 106 is constructed as a unitary component using additive manufacturing process. The cassette body riser 106c includes one or more channels 108 that are each configured to retain a solid phase test strip 200. Each channel 108 may include one or more clips, straps or retainers that hold the test strip 200 in place within the channel 108. Each channel 108 has a width that is approximately the same width or slightly wider than the corresponding test strip 200. In this way, a technician conducting the RCP test can easily place the test strip 200 in the appropriate channel 108 where it is secured during the RCP test. In the depicted embodiments, the cassette 102 includes three channels 108, with two channels 108 designated for testing samples 202 and a third channel 108 acting as a control to indicate when the development process is complete.

The cassette 102 further includes one or more solvent wells 110 located in the cassette body base 106a. Each of the channels 108 extends into a corresponding one of the solvent wells 110 such that when the test strip 200 is placed in the channel 108, a lower end of the test strip 200 extends into the solvent well 110, as best depicted in FIG. 2. Each solvent well 110 includes a fill port 112. In exemplary embodiments, each fill port 112 is horizontally disposed on the cassette body 106 to facilitate placing an appropriate volume of test solvent 204 into the corresponding solvent well 110. In some embodiments, the solvent wells 110 are connected to one another within the cassette body 106. In other embodiments, the solvent wells 110 are separated from one another within the cassette body 106. In some embodiments, each of the solvent wells 110 includes a spillover port 114 at the appropriate height within the solvent well 110 to prevent the technician from overfilling solvent 204 within the solvent well 110. The spillover port 114 extends through the cassette body 106 to maintain the appropriate depth of solvent 204 within the solvent well 110.

The cassette body 106 further includes an upper template slot 116 and a lower template slot 118 that cooperate to facilitate the installation and removal of the template 104. As illustrated in FIG. 2, the upper and lower template slots 116, 118 are located in the cassette body head 106b and cassette body base 106a such that the channels 108 and test strips 200 are located between the template 104 and the cassette body riser 106c.

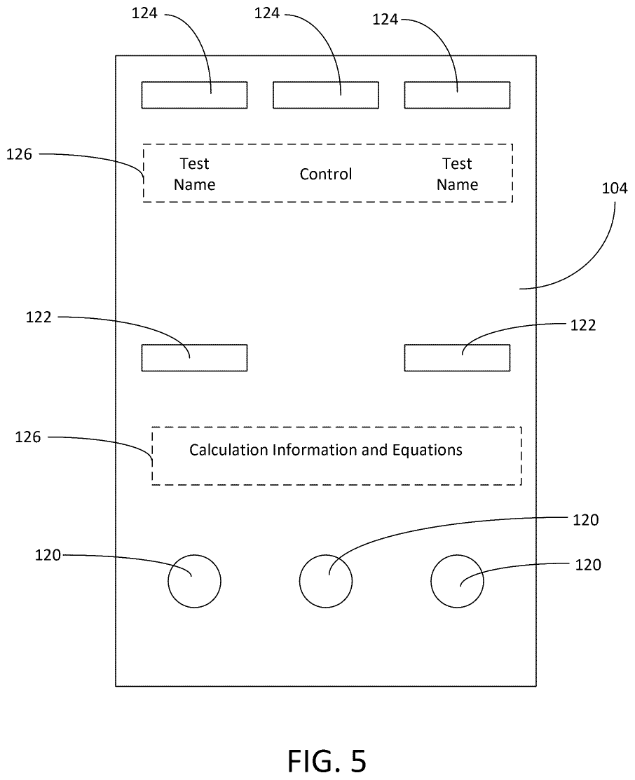

As best illustrated in FIG. 5, the template 104 is generally configured as a thin rectangular sheet that can be constructed from cardstock, metal, glass or a translucent or transparent plastic to permit the visual observation of the test strips 200 behind the template 104 when the template 104 is installed within the upper and lower template slots 116, 118. In some embodiments, each template 104 is designed for a specific RCP test and the RCP test system 100 can be provided with a large number of exchangeable templates 104. Each template 104 can include one or more sample apertures 120, cut line windows 122, and solvent front windows 124. The sample apertures 120 facilitate the accurate placement by the technician of the radiopharmaceutical sample 202 on the appropriate portion of the test strip 200. The cut line windows 122 facilitate the accurate marking by pencil or other writing instrument of a cut line on the test strip 200. The solvent front windows 124 allow the technician to easily determine by visual inspection when the solvent front 208 reaches the top of the test strip 200. Each test-specific template 104 can include visual indicia 126 that may include test information, property type of solvent 204 and test strip 200, analytical equations, calculations or instructions to facilitate the selection of the appropriate template 104 and the uniform application of the RCP test using the template 104.

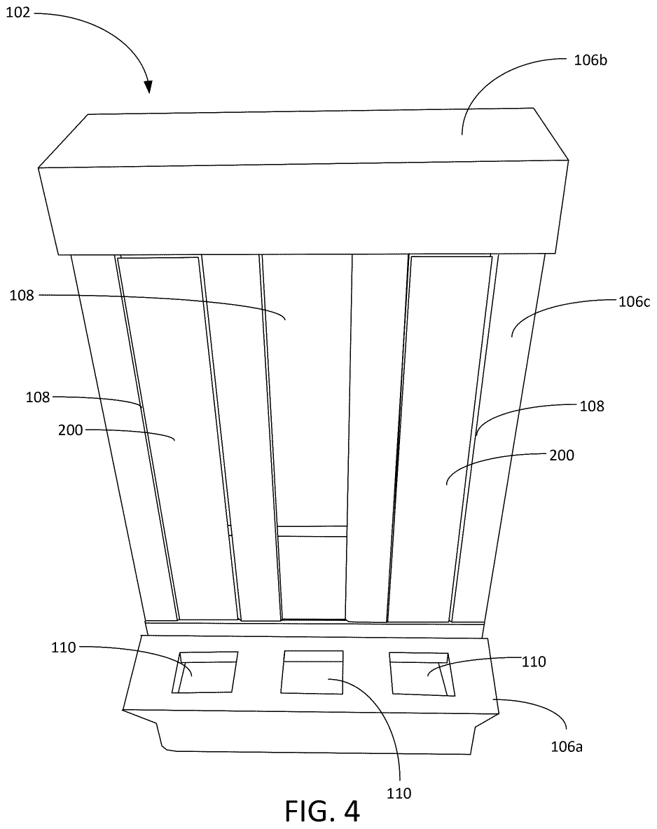

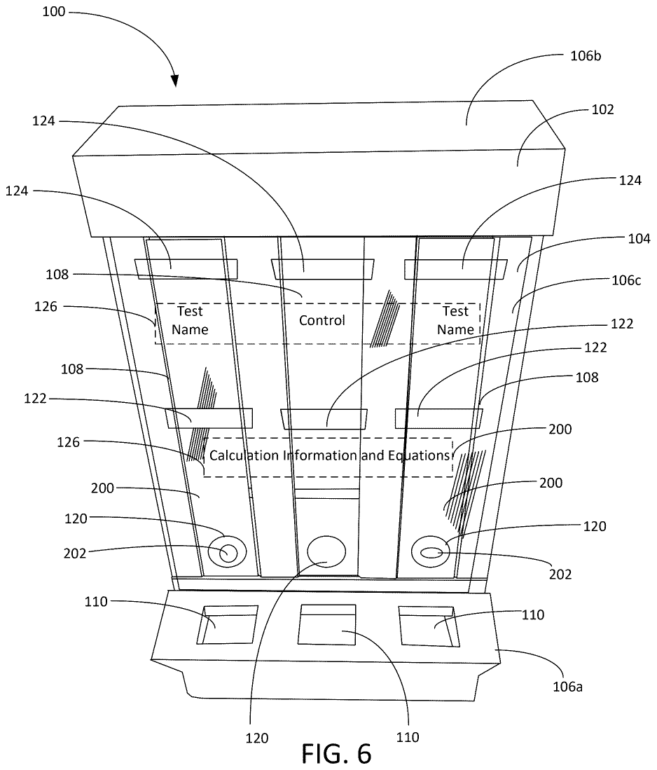

In one method of using the RCP system 100, the technician begins by selecting the appropriate template 104 for the RCP test. The technician can then place each test strip 200 within the corresponding channel 108 of the cassette body 106, as depicted in FIG. 4. The selected template 104 can then be placed over the test strips 200 by sliding the template 104 into the upper and lower template slots 116, 118, as depicted in FIG. 6. The technician then marks the test strips 200 with a cut line 206 using a pencil or other writing utensil through the cut line windows 122. The technician marks the test strips 200 through the solvent front windows 124 with an appropriate color pen to designate when the solvent front 208 reaches the end of the test strip 200 when the exposure is complete.

Once the test strips 200 have been appropriately marked through the template 104, the technician can apply the sample 202 to the test strips 200 through the sample apertures 120 using a dropper or 1 milliliter (mL) tuberculin syringe. The sample 202 is typically a small volume ranging from 5 to 10 microliters (μL). The sample apertures 120 are located on the template 104 to ensure that the sample is placed on the test strip 200 at the appropriate distance from the solvent end of the test strip 200. The cassette 102 loaded with the test strips 200 and template 104 can be positioned such that the cassette body riser 106c is horizontal on a desk or table to facilitate the placement of marks and radiopharmaceutical sample on the test strips 200 through the template 104.

Once the test strips 200 have been marked and spotted with the sample 202, the cassette 102 can be returned to an upright position with the cassette body base 106a in contact with the desk or table. The technician can then add the appropriate quantity and type of solvent 204 into the solvent wells 110 through the corresponding fill ports 112. For example, the technician can be instructed by the template 104 to add 1 mL of the specified solvent 204 to each solvent well 110 using a dropper vial. The configuration of the solvent well 110 and channels 108 within the cassette 102 prevents the accidental immersion of the sample 202 in the solvent 204.

Once the solvent 204 has been added to the solvent wells 110, the solvent 204 will begin to ascend the test strip 200. For most chromatograms, the development process will be complete in about 2 minutes and the solvent front 208 will reach the portion of the test strip 200 visible through the solvent front window 124. The technician can then remove the template 104 from the cassette 102 and then remove the developed test strips 200 from the cassette 102. As required by the particular RCP test, the technician can then cut the test strips 200 along the cut line 206 so the bottom and top portions of the developed test strips 200 can be properly analyzed using the specified radiation detection equipment.

Thus, the embodiments of the present disclosure are well adapted to carry out the objects and attain the ends and advantages mentioned above as well as those inherent therein. While the inventive device and system have been described and illustrated herein by reference to particular non-limiting embodiments in relation to the drawings attached thereto, various changes and further modifications, apart from those shown or suggested herein, may be made therein by those of ordinary skill in the art, without departing from the spirit of the inventive concepts. For example, although the RCP test system 100 is disclosed herein in connection with RCP tests using ITLC methods, it will be appreciated that the RCP test system 100 may find utility in other applications that require the consistent and accurate development of samples using mobile solvents and solid phase test strips.

What is claimed is:

1. A radiochemical purity (RCP) test system for developing a radiopharmaceutical sample with a test strip and a solvent during an RCP test, the RCP test system comprising:
a test template specific to the RCP test; and
a cassette configured to hold the test strip in proper registration with the template.

2. The RCP test system of claim 1, wherein the cassette comprises a channel configured to retain the test strip during the RCP test.

3. The RCP test system of claim 2, wherein the cassette further comprises a solvent well configured to contain a selected volume of the solvent.

4. The RCP test system of claim 3, wherein the solvent well and channel cooperate to place the test strip at a suitable depth in the solvent within the solvent well.

5. The RCP test system of claim 4, wherein the solvent well comprises a fill port.

6. The RCP test system of claim 5, wherein the fill port is horizontally oriented when the cassette is in an upright position.

7. The RCP test system of claim 1, wherein the test template comprises:
a sample aperture;
a cut line window; and
a solvent front window.

8. The RCP test of claim 7, wherein the test strip is captured between the test template and the cassette.

9. The RCP test system of claim 8, wherein the test template further comprises visible indicia that provides information about the specific RCP test.

10. A cassette for use in a radiochemical purity (RCP) test, the cassette comprising:
a cassette body including a base, a head and a riser extending between the base and the head;
at least one channel formed in the riser and configured to retain a test strip between the test template and the cassette body;
a lower template slot in the base, wherein the lower template slot is configured to hold a test template in front of the test strip; and
a solvent well disposed in the base and positioned such that a lower portion of the test strip extends into the solvent well when the test strip is retained in the corresponding channel.

11. The cassette of claim 10, wherein the base further comprises a fill port in fluid communication with the solvent well.

12. The cassette of claim 11, wherein the base further comprises a spillover port configured to limit a solvent height within the solvent well to a predetermined maximum level.

13. The cassette of claim 10, wherein the cassette comprises a plurality of solvent wells and wherein each of the plurality of solvent wells is fluidly isolated from the other solvent wells.

14. The cassette of claim 10, further comprising an upper template slot in the head that cooperates with the lower template slot to hold the test template.

15. A method of performing a radiochemical purity (RCP) test, comprising:
inserting a first test strip into a first channel of a cassette;
installing a test-specific template onto the cassette such that the template aligns with the first test strip;
marking the first test strip with a cut line and a solvent-front line through respective windows in the template;
depositing a first radiopharmaceutical sample onto the first test strip through a sample aperture in the template;
introducing a first solvent into a first solvent well of the cassette through a fill port;
allowing the first solvent to ascend the first test strip until the first solvent reaches the solvent-front line of the first test strip; and
cutting and analyzing the first test strip to determine the radiochemical purity of the first radiopharmaceutical sample.

16. The method of claim 15, further comprising a step of selecting the template based on a specific radiopharmaceutical being tested.

17. The method of claim 15, wherein the cassette is placed horizontally during marking of the first test strip and thereafter placed upright during development.

18. The method of claim 15, further comprising the steps of:
inserting a second test strip into a second channel of a cassette;
installing the test-specific template onto the cassette such that the template aligns with the first test strip and the second test strip;
depositing a second radiopharmaceutical sample onto the second test strip through a sample aperture in the template;
introducing a second solvent into a second solvent well of the cassette through a fill port;
allowing the second solvent to ascend the second test strip until the second solvent reaches the solvent-front line of the second test strip; and
cutting and analyzing the second test strip to determine the radiochemical purity of the second radiopharmaceutical sample.

19. The method of claim 18, wherein the step of allowing the second solvent to ascend the second test strip until the second solvent reaches the solvent-front line of the second test strip takes place contemporaneously with the step of allowing the first solvent to ascend the first test strip until the first solvent reaches the solvent-front line of the first test strip.

20. The method of claim 18, wherein the first and second radiopharmaceutical samples are different.
